(19) United States
(12) Patent Application Publication
(10) Pub. No.: US 2013/0223306 A1
(43) Pub. Date: Aug. 29, 2013

(54) Buffered Frames Indication Enhancement To Enable Power Savings

(71) Applicants: Zhong-Yi Jin, Albany, CA (US); Klaus F. Doppler, Albany, CA (US); Taejoon Kim, Berkeley, CA (US); Chittabrata Ghosh, Union City, CA (US)

(72) Inventors: Zhong-Yi Jin, Albany, CA (US); Klaus F. Doppler, Albany, CA (US); Taejoon Kim, Berkeley, CA (US); Chittabrata Ghosh, Union City, CA (US)

(73) Assignee: Nokia Corporation

(21) Appl. No.: 13/403,116

(22) Filed: Feb. 23, 2012

(51) Int. Cl. H04W 52/02; H04W 84/02

(52) U.S. Cl. 370/311

(57) ABSTRACT

A method includes receiving, by an apparatus, a signaling element containing an indication whether there are buffered individually addressed frames for at least one device within a group of devices; determining, by the apparatus, whether the apparatus belongs to a group for which there are no buffered individually addressed frames, based on the indication; and if the apparatus belongs to a group for which there are no buffered individually addressed frames, entering a lower power state without waiting to receive a next signaling element.

### TECHNICAL FIELD

The exemplary and non-limiting embodiments of this invention relate generally to wireless communication systems, methods, devices and computer programs and, more specifically, relate to wireless communication systems in which an access node buffers frames at least for individually addressed transmissions. IEEE 802.11 compliant systems are non-limiting examples of these types of systems.

### BACKGROUND

In many wireless communication systems there are devices which attempt to conserve their operating (e.g., battery) power. There are different approaches as to how to enable power savings for these kinds of devices. Some of the approaches are alternative and some may be complementary to each other. However, when the number of devices within a wireless network increases the known types of power saving methods may not be sufficient.

### SUMMARY

In accordance with a first aspect thereof embodiments of this invention provide a method that comprises receiving, by an apparatus, a signaling element comprising an indication whether there are buffered individually addressed frames for at least one device within a group of devices; determining, by the apparatus, whether the apparatus belongs to a group for which there are no buffered individually addressed frames, based on the indication; and if the apparatus belongs to a group for which there are no buffered individually addressed frames, entering a lower power state without waiting to receive a next signaling element transmission.

In accordance with another aspect thereof embodiments of this invention provide a non-transitory computer-readable storage medium associated with an access point. The non-transitory computer-readable storage medium contains a data structure comprised of a first plurality of i bits individual ones of which indicate for a plurality of i stations whether an associated one of the i stations has buffered data at the access point. The data structure further comprises a second plurality of j bits individual ones of which indicate for an individual one of j groups of stations whether any station within the group has buffered data at the access point.

In accordance with yet another aspect thereof embodiments of this invention provide a method that comprises assigning at an apparatus individual ones of devices to one of a plurality of groups of devices; and transmitting a signaling element to the devices. The signaling element is comprised of a first plurality of i bits individual ones of which indicate for a plurality of i devices whether an associated one of the i devices has buffered data at the apparatus. The signaling element further comprises a second plurality of j bits individual ones of which indicate for an individual one of j groups of devices whether any devices within the group has buffered data at the apparatus.

In accordance with yet another aspect thereof the embodiments of this invention provide an apparatus that comprises at least one data processor and at least one memory including computer program code. The at least one memory and computer program code are configured, with the at least one data processor, to cause the apparatus at least to receive a signaling element comprising an indication whether there are buffered individually addressed frames for at least one device within a group of devices; and to determine whether the apparatus belongs to a group for which there are no buffered individually addressed frames. The apparatus is further configured, based on the indication and if it is determined that the apparatus belongs to a group for which there are no buffered individually addressed frames, to enter a lower power state without waiting to receive a next signaling element.

In accordance with still another aspect thereof the embodiments of this invention provide an apparatus that comprises at least one data processor and at least one memory including computer program code. The at least one memory and computer program code are configured, with the at least one data processor, to cause the apparatus at least to assign individual ones of devices to one of a plurality of groups of devices and to transmit a signaling element to the devices. The signaling element is comprised of a first plurality of i bits individual ones of which indicate for a plurality of i devices whether an associated one of the i devices has buffered data at the apparatus. The signaling element is further comprised of a second plurality of j bits individual ones of which indicate for an individual one of j groups of devices whether any devices within the group has buffered data at the apparatus.

In accordance with still another aspect thereof the embodiments of this invention provide an apparatus that comprises means for receiving at a station a signaling element transmitted with a beacon transmission, the signaling element comprising an indication as to whether there are buffered individually addressed frames for at least one station within a group of stations. The apparatus further comprises means for determining whether the station belongs to a group for which there are no buffered individually addressed frames, based on the indication, and means, responsive to a determination that the station belongs to a group of stations for which there are no buffered individually addressed frames, for entering a lower power state without waiting to receive a next signaling element from a next beacon transmission.

In accordance with yet another aspect thereof the embodiments of this invention provide an apparatus that comprises means for assigning at an access point of a wireless local area network individual ones of stations to one of a plurality of groups of stations. The apparatus further comprises means for transmitting a signaling element to the stations. The signaling element is comprised of a first plurality of i bits individual ones of which indicate for a plurality of i stations whether an associated one of the i stations has buffered downlink data at the access point. The signaling element further comprises a second plurality of j bits individual ones of which indicate for an individual one of j groups of stations whether any station within the group of stations has buffered downlink data at the access point.

### BRIEF DESCRIPTION OF THE DRAWINGS

The foregoing and other aspects of the exemplary embodiments of this invention are made more evident in the following Detailed Description, when read in conjunction with the attached Drawing Figures, wherein:

FIG. 1 shows the conventional TIM element format (in bytes).

FIG. 2 shows the use of multiple (N) TIM elements for 6000 STAs, and reproduces slide 6 of a document 2012 117 0 TGah, TIM operation.

FIG. 3 illustrates an overall simplified block diagram of a system that includes a plurality of STAs and an AP, the system being configured so as to operate in accordance with the embodiments of this invention.

FIG. 4 shows one non-limiting example where STA group bits are reserved at an end of the TIM bitmap.

FIGS. 5A-5D, collectively referred to as FIG. 5, are useful in explaining a PP-MAC concept that may be used to implement at least some of the embodiments of this invention.

FIGS. 6 and 7 are each a logic flow diagram that illustrates the operation of a method, and a result of execution of computer program instructions, in accordance with the exemplary embodiments of this invention.

### DETAILED DESCRIPTION

It is noted at the outset that while example embodiments of this invention may be described below with reference to IEEE 802.11-type systems, such as an IEEE 802.11ah (sub-1 GHz) system, the embodiments may be applicable to other types of wireless systems including, as an example, current and future cognitive radio systems. In general, the embodiments of this invention are applicable to wireless communication systems wherein a network access node (AN), such as a base station (BS) or an access point (AP), buffers data to be transmitted to user devices (e.g., client devices, user terminals, user equipment, user stations) that are wirelessly connected with the network access node. An aspect of this type of operation may be the use of some type of downlink signaling to inform at least some of the user devices that the network access node has buffered data to be transmitted to at least some of the user devices. The use of this downlink signaling enables a particular user device, one that is informed implicitly or explicitly by the downlink signaling that there currently is no buffered data for it at the network access node, to temporarily enter a lower power mode of operation in order to at least conserve battery power. The downlink signaling may take various forms and may be referred to by different names in different types of wireless networks. In the non-limiting example of an IEEE 802.11 type of system this downlink signaling may be referred to as a ‘traffic indication map’ or TIM. The downlink signaling may be transmitted using various types of downlink channels and transmission formats depending on the specifics of the system. In the non-limiting example of an IEEE 802.11 type of network this downlink signaling may be transmitted by the network access node during a ‘beacon’ transmission, and is used to indicate to the user devices receiving the beacon transmission for which specific ones of the user devices that the network access node currently has buffered, individually addressed frames (of data).

The following abbreviations that may be found in the specification and/or the drawing figures are defined as follows:
ACK acknowledge
AID association identifier (of a station)
AP access point
HCF hybrid coordination function
HCCA HCF controlled channel access
ISM industrial, scientific, medical (frequency band)
MAC medium access control
PCF point coordination function
PIFS PCF interframe space
PP probe and pull
QoS quality of service
SIFS short interframe space
STA station
TG task group
TIM traffic indication map (bitmap)
WLAN wireless local area network

The TIM information element is described in, for example, section 7.3.2.6 of 802.11-1999. The IEEE-802.11 standards use a bitmap to indicate to sleeping STAs if the AP has any buffered frames for the sleeping STAs. Because STAs should listen to at least one beacon before the listen interval, the AP periodically sends this bitmap on its beacons as an information element. The bitmask (TIM) consists of 2008 bits, each bit representing an Association Id (AID) of a STA.

General reference with regard to power management may be made to section 11.2, “Power management”, sub-section 11.2.1 “Power management in an infrastructure network” of IEEE Std. 802.11-2007 (pgs. 425-433).

Some embodiments of this invention provide an enhancement, such as a MAC enhancement, that addresses a limitation of using multiple TIM elements to support the power saving operations of as many as 6000 stations, an important requirement for IEEE 802.11ah.

Without limiting the embodiments of this invention, some embodiments of this invention relate to development of the new WLAN standard amendment in 802.11 TGah. The task group is developing a WLAN variant that uses the 900 MHz ISM band (i.e., 902 MHz to 928 MHz) for low bandwidth networking in which client devices are expected to include sensors and control devices. A single 802.11ah AP is expected to be capable of serving thousands of clients, a capability that is not typically possible with the legacy 802.11 standard and implementations.

Some embodiments of this invention provide a novel use of the traffic indication map (TIM) field with which an AP traditionally indicates whether the AP has frames buffered for a single client device that operates in the power save mode. The current TIM structure is not suitable for cases in which an AP serves thousands of client devices.

Some embodiments of this invention use the TIM field to indicate buffer state per client device group, instead of signaling each client device separately, while in some other embodiments the TIM field may indicate buffer state per client device group for a first portion of devices, and buffer state per client device for a second portion of devices. Additionally, an example aspect of the invention provides novel rules for the TIM bit setting in the AP. Traditionally the TIM bit is set whenever the AP has some buffered traffic for the client device.

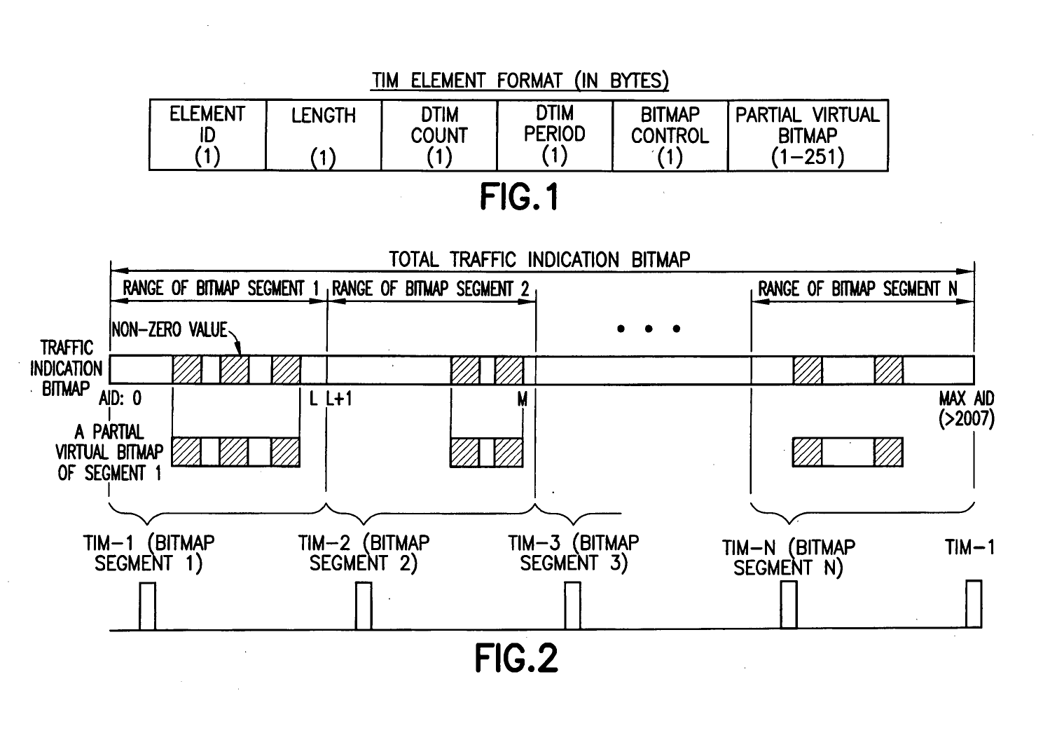

The TIM is an enabling element in the IEEE 802.11 standards for power saving modes. According to the current standard the partial virtual bitmap of a TIM element has a maximum length of 2008 bits and therefore may only be used to support 2007 STAs (−1 for broadcast). In that IEEE 802.11ah is required to support 6000 STAs, the operation of the TIM element in the existing IEEE 802.11 standards in not adequate for use with IEEE 802.11ah. That is, simply indicating the buffer state separately per client device does not enable an efficient use of downlink spectrum when the potential number of client devices becomes large (e.g., as many as 6000 potential client devices). FIG. 1 shows the conventional TIM element format (in bytes).

Two amendments have been presented to the TGah (task group ah). See in this regard 2012 117 0 TGah, TIM operation, Minyoung Park et al.; and 2011 1550 1 TGah, Extension of AID and TIM in Support of 6000 STAs in 802.11ah, Yuan Zhou et al. Both of these proposed amendments use multiple TIM elements to represent an entire TIM bitmap. For example, three TIM elements of 2000 bits each (partial virtual bitmap) could be used to represent the entire traffic bitmap of 6000 stations.

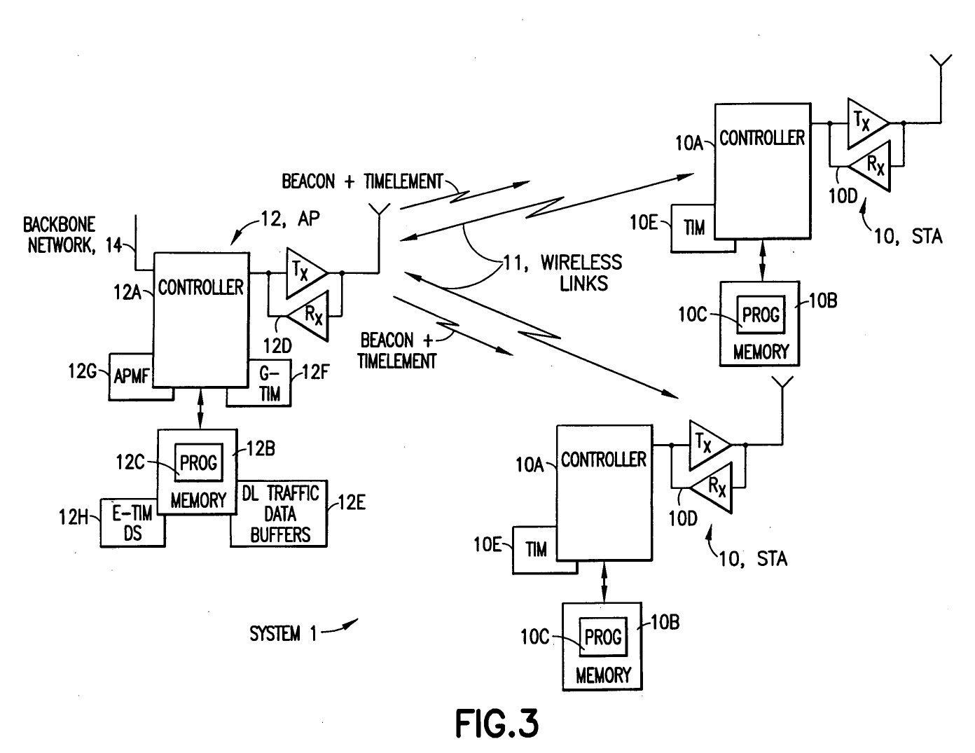

FIG. 2 shows the use of multiple (N) TIM elements for 6000 STAs, and reproduces slide 6 of the document 2012 117 0 TGah, TIM operation.

However, one disadvantage of the existing proposals is that some STAs may have to wait for multiple beacon intervals before receiving its own TIM bit. This is because TIM elements are sent in beacons from the AP and one beacon may carry only one TIM element. Since a beacon is typically sent every 100 ms, the existing TIM proposals could significantly increase the energy consumption of STAs. For example, if three TIM elements are used for 6000 STAs, a STA that has no downlink traffic may have to wait for two beacon intervals before receiving its own TIM bit (0) and then going back to sleep (entering a low power operational mode).

As will be described below some embodiments of this invention enable a beacon to carry more than one TIM element and/or to increase the effective size of the TIM.

As used herein a ‘beacon’ may be considered as a downlink signaling transmission that is broadcast to the STAs from the AP, e.g., as a DL broadcast transmission that includes signaling information such as the TIM. The TIM may be considered as a DL signaling element, such as a bitmap, that contains information that indicates status of a DL data buffer of the AP for different ones of the STAs served by the AP. For example, and for a particular STA, does or does not the corresponding DL data buffer at the AP contain data to be transmitted to the STA?

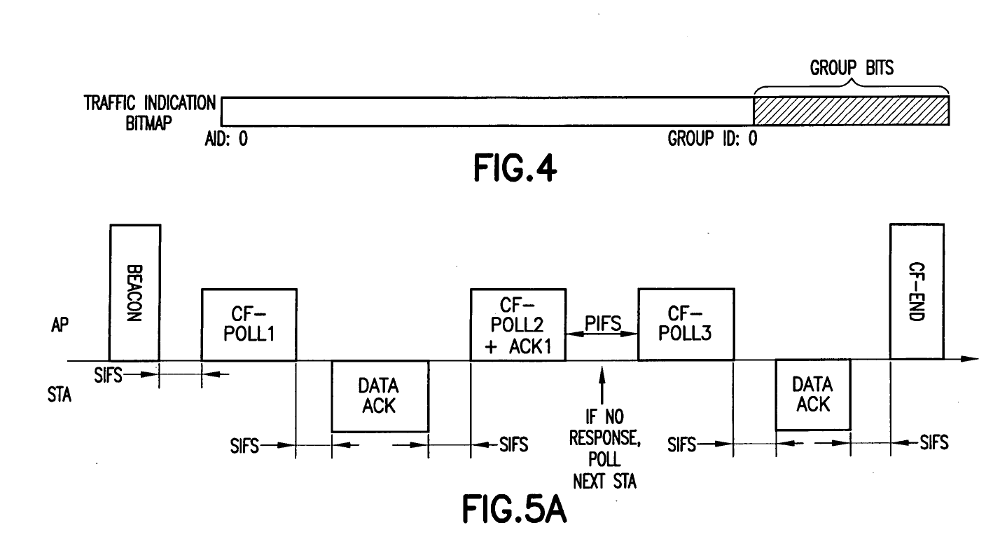

Before describing the embodiments of this invention in further detail reference is made to FIG. 3 for showing an overall simplified block diagram of a system 1 that includes a plurality of apparatus which may be referred to without a loss of generality as client devices or nodes or stations (STAs) 10. The system 1 further includes another apparatus which may be referred to without a loss of generality as a base station or a network access node or an access point (AP) 12 that communicate via wireless radio frequency (RF) links 11 with the STAs 10. In the illustrated embodiment the RF links 11 may operate in the ISM band with a frequency less than 1 GHz, such as in a band in the 900 MHz region. While two STAs 10 are shown in practice there could hundreds or even thousands of STAs that are served by the AP 12. Each STA 10 includes a controller 10A, such as at least one computer or a data processor, at least one non-transitory computer-readable memory medium embodied as a memory (MEM) 10B that stores a program of computer instructions (PROG) 10C, and at least one suitable RF transmitter (Tx) and receiver (Rx) pair (transceiver) 10D for bidirectional wireless communications with the AP 12 via one or more antennas. The AP 12 also includes a controller 12A, such as at least one computer or a data processor, at least one computer-readable memory medium embodied as a memory (MEM) 12B that stores a program of computer instructions (PROG) 12C, and at least one suitable RF transceiver 12D for communication with the STAs 10 via one or more antennas. The AP 12 may be assumed to be interfaced with some type of backbone network 14 from which it receives data to be transmitted to the STAs 10 and to which it sends data received from the STAs 10.

For the purposes of describing the exemplary embodiments of this invention the STA 10 may be assumed to also include a TIM function 10E, and the AP 12 may include downlink (DL) traffic data buffers 12E, a STA grouping and TIM (G-TIM) function 12F, and an advanced power management function (APMF) 12G, as described in detail below.

At least one of the programs 10C and 12C is assumed to include program instructions that, when executed by the associated controller, enable the device to operate in accordance with the exemplary embodiments of this invention, as will be discussed below in greater detail. That is, the exemplary embodiments of this invention may be implemented at least in part by computer software executable by the controller 10A of the STA 10 and/or by the controller 12A of the AP 12, or by hardware, or by a combination of software and hardware (and firmware). The functionality of the TIMs 10E may also be implemented at least in part by computer software executable by the controller 10A of the STA 10, or by hardware, or by a combination of software and hardware (and firmware). The functionality of the G-TIM 12F and APMF 12G may also be implemented at least in part by computer software executable by the controller 12A of the AP 12, or by hardware, or by a combination of software and hardware (and firmware).

The various controllers/data processors, memories, programs, transceivers and interfaces depicted in FIG. 3 may all be considered to represent means for performing operations and functions that implement the several non-limiting aspects and embodiments of this invention.

In general the various embodiments of the STA 10 may include, but are not limited to, sensors and control devices, although the STAs 10 could also be, by example, mobile communication devices, desktop computers, portable computers, image capture devices such as digital cameras, gaming devices, music storage and playback appliances, Internet appliances permitting wireless Internet access and browsing, sensors, and portable units or terminals that incorporate combinations of such functions.

The computer-readable memories 10B and 12B may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The controllers 10A and 12A may be of any type suitable to the local technical environment, and may include one or more of general purpose computers, special purpose computers, microprocessors, digital signal processors (DSPs) and processors based on multi-core processor architectures, as non-limiting examples.

The use of some embodiments of this invention overcomes the disadvantages and problems mentioned above by providing the G-TIM 12F that reserves/adds/uses N bits of the partial virtual bitmap in a TIM element for groups of STAs 10. An aspect of this operation of the G-TIM 12F is partitioning the STAs 10 into N groups, where an N^{th} reserved bit in the partial virtual bitmap indicates traffic information for the N^{th} group of STAs 10. The N^{th} bit is set to 1 if any one of the STAs 10 in the Nth group have downlink traffic at the AP 12 DL data buffers 12E, otherwise the bit is set to 0 (or vice versa). The N group bits may be included in each and every TIM element so that when a STA 10 receives a TIM element during a beacon transmission it may quickly determine if its associated group has downlink traffic, even though its own TIM bit is not included in the TIM element. If there is no downlink traffic indicated for the particular STA group the STA 10 may immediately go back to sleep without waiting to receive additional TIMs (beacons).

It should be noted that IEEE 802.11TGah also discusses the use of short beacons. Short beacons (e.g., transmitted every 10 or 20 ms) have limited overhead and may not include the N group bits.

More specifically, in some embodiments the STA 10 enters a lower power mode without waiting to receive the next beacon transmission (a beacon transmission following the received beacon transmission). Note that in some embodiments the STA 10 could skip several beacon transmissions while in the lower power mode of operation. Further in accordance with some embodiments, and after expiration of some certain defined power saving period, the STA 10 ‘wakes up’ and waits to receive a new beacon transmission.

Further in accordance with some embodiments of this invention, if the STA 10 does not belong to a group for which it is indicated that there are no buffered individually addressed frames, the STA 10 waits to receive a next beacon transmission in order to obtain information as to whether there is at least one buffered individually addressed frame for the STA 10 itself.

The G-TIM 12F composes what may be referred to as an enhanced TIM (E-TIM) to include the normal TIM bits and the additional group bits and stores at least temporarily prior to transmission of the beacon the E-TIM in what may be referred to as an E-TIM data structure (DS) 12H in the memory 12B (see FIG. 3). Note that the E-TIM DS 12H may be embodied simply as a transmit buffer that is loaded with information just prior to being encoded and transmitted by the AP 12.

The E-TIM DS 12H may be considered as being stored a non-transitory computer-readable storage medium associated with the AP 12. The E-TIM DS 12H may be considered to comprise a first plurality of i bits individual ones of which indicate for a plurality of i STAs 10 an associated one of the i STAs 10 has buffered data at the AP 12 (in the DL traffic data buffers 12E). The E-TIM DS 12H data structure may further comprise a second plurality of j bits individual ones of which indicate for an individual one of j groups of STAs 10 whether any STA within the group has buffered data at the AP 12.

Note, however, that the content of the second plurality of j bits may be computed in real time from the first plurality of i bits given a mapping from STA to Group, where the non-transitory computer-readable storage medium (memory 12B) may also contain a data structure for defining the mapping from STA to Group. As was noted above, the E-TIM data structure (DS) 12H may be embodied as a transmit buffer in some embodiments. In this case part of the transmit buffer may be loaded with information (at least the j bits) that is calculated in real time or substantially real time just prior to transmission. The grouping of the STAs 10 may be accomplished in such a way that those STAs 10 that tend to have downlink traffic at about the same time are grouped together.

Typically, this grouping may involve STAs 10 that function as a group or have certain dependencies. For instance, enabling an alarm system may involve sending commands to all of the STAs 10 than control alarms at different locations of a home or a business. Similarly, if a heater and an air conditioner are two separate units controlled by two separate STAs 10, turning on the heater typically means turning off the air conditioner and vice versa.

In terms of assigning a particular STA 10 to a particular group, the mapping algorithm may be either based on, for example, application-level knowledge and/or on statistics (collected in real time or based on historical information). The signaling of a STA 10 assignment to a particular group may be part of an association message, a message exchanged after the association is accomplished, or hard-programmed into some or all of the STAs 10 during deployment, as several non-limiting examples.

In general STAs 10 with similar applications may be grouped together or STAs 10 in the same geographical area may be grouped together. Assignment to groups may occur in the association phase or by sending control frames, or a control frame added to data frame. The group association of a particular STA 10 may be changed over time but typically it may be basically static.

Further in accordance with the non-limiting embodiments of this invention there is provided the advanced power management function (APMF) 12G for the AP 12. The advanced power management function 12G operates as follows. Based on the amount of buffered downlink (DL) traffic in the buffers 12E and also QOS/application specific information, the AP 12 delivers the downlink traffic in groups. The ‘application specific’ information generally implies that if the STAs 10 are used to perform certain applications, the downlink messages may need to be delivered in application specific ways/orders that may not be part of QoS. As one non-limiting example in a hospital environment, the considerations for a group of STAs 10 that are associated with a patient health-related application or applications may be different than the considerations for a group of STAs that are associated with a patient entertainment application or applications.

The AP 12 performs this task of delivering the downlink traffic in groups by selectively setting certain group bits in the TIM to zero even though there may be downlink traffic for one or more of the STAs 10 in those groups. The decision to set the group bit to zero can be based on, for example, the total amount of buffered data for the group not exceeding some threshold amount. The threshold value may be fixed or it may be a function of one or more criteria such as the QoS associated with the particular group of STAs 10. For example, the threshold value may be higher for a group of STAs 10 having a non-real-time ‘best-effort’ type of QoS, as opposed to a group of STAs that require low latency DL data delivery. Other criteria can include the application-specific nature of the group of STAs 10, e.g., some applications may be deemed to be more critical that others and may have by default a lower buffered data threshold.

The AP 12 may rotate amongst the groups of STAs 10 to deliver all downlink traffic by controlling the group bits. By doing so the advanced power management technique (APMF 12G) of the AP 12 may minimize the waiting time of the STAs 10 without using a large number of group bits. As one non-limiting example, the AP may use seven out of the 2008 bits per TIM element to create seven groups for the advanced power management function. These seven bits could otherwise be wasted for 6000 STAs when three TIM elements are used.

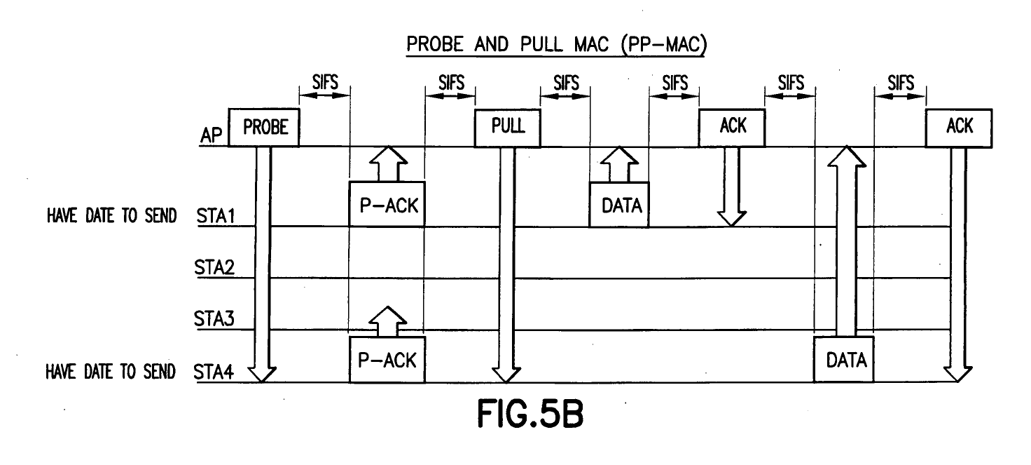

The group bits may be reserved anywhere within the partial virtual bitmap of a TIM as long as they may be distinguished from other kinds of bits. FIG. 4 shows one non-limiting example where the group bits are reserved at the trailing end of the TIM bitmap. In another non-limiting embodiment they may be reserved at the leading end of the TIM bitmap. In other embodiments the group bits may be reserved somewhere in the middle of the TIM bitmap. In all of these embodiments it is assumed that the STAs 10 can distinguish the group bits from other TIM bits and recover and correctly interpret them.

Note that in some embodiments the group related bits may appear earlier, although the beacon may typically also include information about the group(s) of STAs or the range of AIDs included in the current TIM. This information may likely be transmitted before the TIM itself.

This technique may readily accommodate a Probe and Pull MAC (PP-MAC) technique proposed in “MAC considerations for 802.11ah (Probe and Pull MAC)”, 2011-11-07, by the inventors and others.

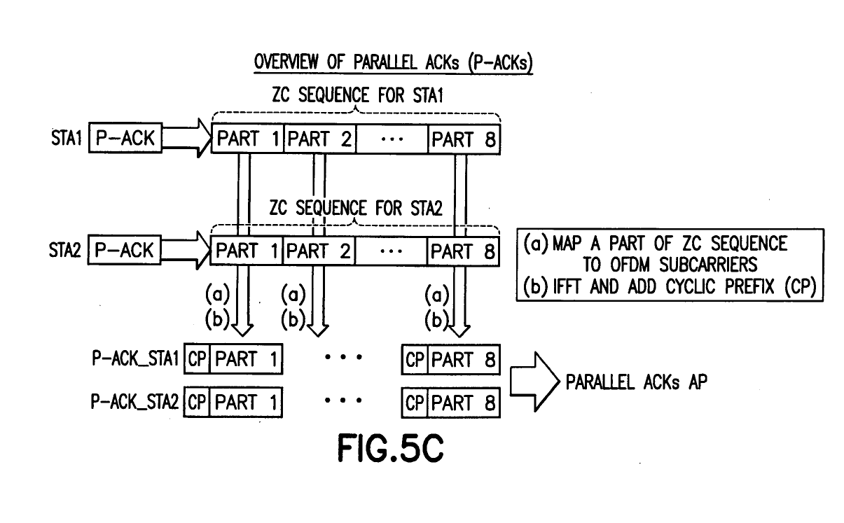

Briefly, the benefits of contention-free MAC, such as PCF/HCCA, include that it is deterministic and fair, that it is efficient for both low duty-cycle and heavy/bursty traffic, that it provides higher reliability and lower deployment cost, that there is no hidden terminal problem, and that it is energy efficient. Reference can be made to FIG. 5A.

However, the use of PCF/HCCA is not suitable for large networks. For example, consider an IEEE 802.11ah deployment with a 2 MHz bandwidth and 6000 STAs. In this case assume that there are 26 data bits/OFDM Symbols (BPSK 1/2), 40 μs symbol duration, SIFS=160 μs, PIFS=208 μs, CF-Poll/-ACK message (28 bytes) at 8.6 symbols (344 μs), and the data (250 bytes)=3076 μs+PLCP (400 μs)+MAC header(344 μs). If X % of the STAs 10 have one UL data packet, the total time to collect all UL data at the AP 12 is approximately: 6000 * (1−X) * (CF-POLL+PIFS)+6000 * X * (CF-POLL-ACK+SIFS+Data+SIFS). As the value of X increases the time in seconds increases as well (e.g., based on the foregoing conditions when X=100% the total time to collect data from 6000 STAs may be almost 27 seconds).

FIG. 5B shows the PP-MAC concept. In this approach the STAs 10 are partitioned into groups and the AP 12 sends a probe to a group of STAs. Those STAs with data to send (STA1 and STA4 in this example) will parallel ACK (P-ACK) concurrently (in a time-aligned manner). The AP 12 resolves the parallel ACKs that it receives with the use of Zadoff-Chu sequences, and then the AP 12 schedules and initiates data transmissions with a PULL operation.

FIG. 5C shows an overview of the P-ACKs for two STAs (STA1 and STA2), while FIG. 5D shows the performance improvement when using PP-MAC and the gains achieved as compared to PCF.

In accordance with some of the embodiments of this invention, assume that probe requests are sent with every full beacon (100 ms periodicity) and with four short beacons (20 ms periodicity) between the full beacons. The beacons would typically probe a group of 32 STAs 10 and the related TIM only indicates DL traffic for those 32 STAs. The group bits in the TIM may indicate traffic for 5×32 STAs probed during a full beacon interval. In this case 6000 STAs 10 would be grouped into about 40 groups, and only 40 bits are needed to indicate if a STA 10 within the group has buffered DL traffic. These very compressed group bits may be used in the short beacons whereas the full beacon may use a smaller group size of, e.g., 32 with about 200 bits to indicate traffic for the groups.

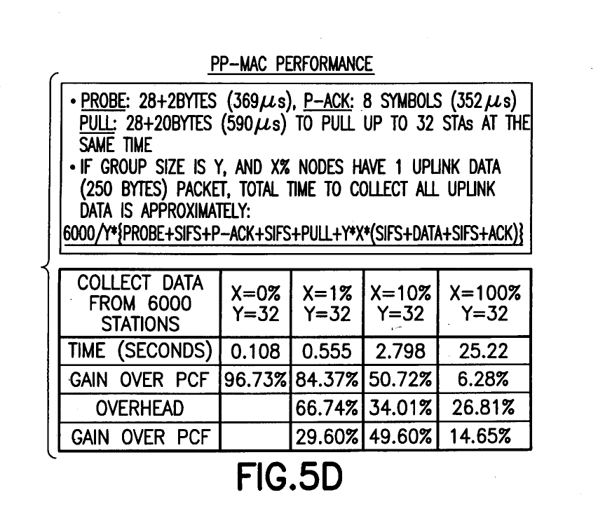

An exemplary aspect of this invention is a method for operating an apparatus in a power save mode in a wireless network. FIG. 6 is a logic flow diagram that illustrates the operation of the method, and a result of execution of computer program instructions, in accordance with the exemplary embodiments of this invention. In accordance with these exemplary embodiments the method performs, at Block 6A, a step of receiving, by an apparatus, a signaling element comprising an indication whether there are buffered individually addressed frames for at least one device of a group of devices. The method includes, at Block 6B, a step of determining, by the apparatus, whether the apparatus belongs to a group for which there are no buffered individually addressed frames, based on the indication. The method includes, at Block 6C, a step of, if the apparatus belongs to a group for which there are no buffered individually addressed frames, entering a lower power state without waiting to receive a next signaling element transmission.

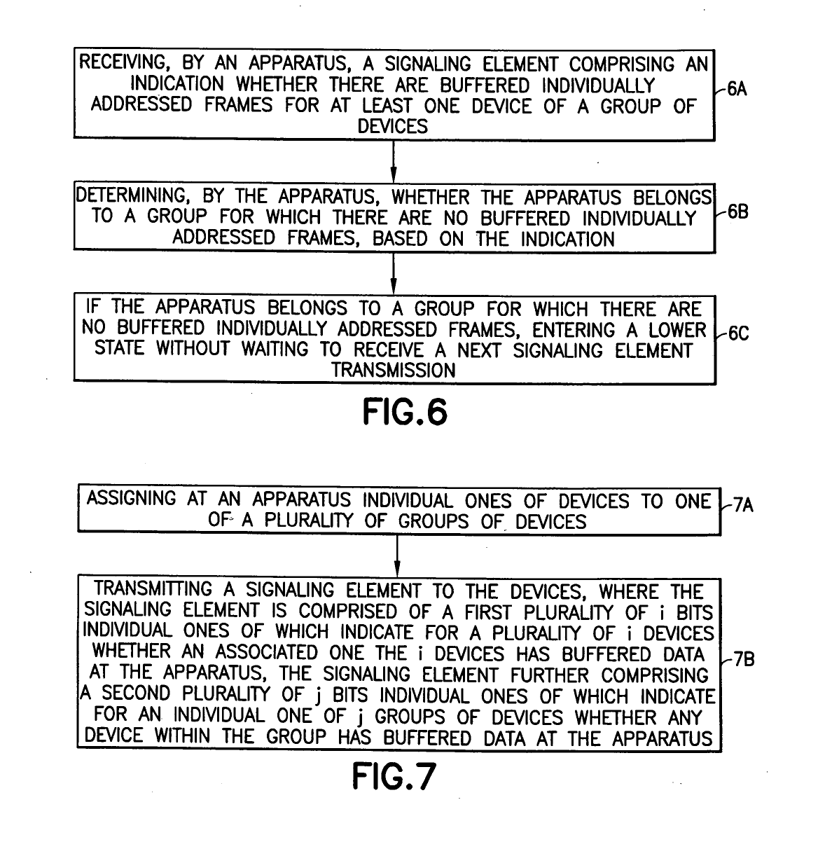

FIG. 7 is a logic flow diagram that illustrates the operation of another method, and a result of execution of computer program instructions, further in accordance with the exemplary embodiments of this invention. In accordance with these exemplary embodiments the method performs, at Block 7A, a step of assigning at an apparatus individual ones of stations to one of a plurality of groups of devices. At Block 7B there is a step of transmitting a signaling element to the devices, where the signaling element is comprised of a first plurality of i bits individual ones of which indicate for a plurality of i devices whether an associated one of the i devices has buffered data at the apparatus, the signaling element further comprising a second plurality of j bits individual ones of which indicate for an individual one of j groups of devices whether any devices within the group has buffered data at the apparatus.

The various blocks shown in FIGS. 6 and 7 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention. For example, while described in the context of a TIM transmission containing one bitmap with two sets of bits, these two sets of bits may be split into two separate bitmaps and transmitted separately.

Further by example, while the exemplary embodiments have been described in the context of the buffering of individually addressed frames of data for STAs 10, the embodiments of this invention may also be applied to multicast and similar types of data transmissions where some buffered data at the AP 12 is intended for delivery to two or more STAs 10. In this case the STAs 10 could be in the same group of STAs or they could be in two or more different groups of STAs.

As a still further example, while the exemplary embodiments have been described above at least partially in the context of the IEEE 802.11ah system it should be appreciated that the exemplary embodiments of this invention are not limited for use with only this one particular type of wireless communication system, and that they may be used to advantage in other wireless communication systems such as, but not limited to, cognitive radio networks.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements may be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters and information elements (e.g., TIM, etc.) are not intended to be limiting in any respect, as these parameters and information elements may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
receiving, by an apparatus, a signaling element comprising an indication whether there are buffered individually addressed frames for at least one device within a group of devices;
determining, by the apparatus, whether the apparatus belongs to a group for which there are no buffered individually addressed frames, based on the indication; and
if the apparatus belongs to a group for which there are no buffered individually addressed frames, entering a lower power state without waiting to receive a next signaling element transmission.

2. The method as in claim 1, where the indication is included in a traffic indication bitmap information element.

3. (canceled)

4. The method as in claim 1, where the signaling element is received in a beacon, and where the apparatus is a non-access point station of a wireless local area network.

5. The method as in claim 1, where there are N groups of devices, and where the indication comprises a bit in a group of N bits.

6. A non-transitory computer-readable medium that contains software program instructions, where execution of the software program instructions by at least one data processor results in performance of operations that comprise execution of the method of claim 1.

7. (canceled)

8. A method, comprising:
assigning at an apparatus individual ones of devices to one of a plurality of groups of devices; and
transmitting a signaling element to the devices, where the signaling element is comprised of a first plurality of i bits individual ones of which indicate for a plurality of i devices whether an associated one of the i devices has buffered data at the apparatus, the signaling element further comprising a second plurality of j bits individual ones of which indicate for an individual one of j groups of devices whether any device within the group has buffered data at the apparatus.

9. The method as in claim 8, where the j bits are transmitted either prior to or subsequent to transmitting the i bits.

10. The method as in claim 8, further comprising for at least one particular selected group of devices setting an associated one of the j bits to indicate that no device within the particular selected group has buffered data at the apparatus when there actually is buffered data at the apparatus for at least one of the devices within the particular selected group.

11. The method as in claim 10, where a decision is made to set the associated one of the j bits, to indicate that no device within the particular selected group has buffered data at the apparatus, in order to at least reduce energy consumption by the devices within the particular selected group.

12. The method as in claim 11, where the decision is made based at least in part on one or more of a quality of service criterion, an amount of buffered downlink data for the devices within the particular selected group, and an application specific information related to the devices within the particular selected group of devices.

13. (canceled)

14. (canceled)

15. The method as in claim 10, further comprising rotating over time the at least one particular selected group among the j groups of devices.

16. The method as in claim 8, where the signaling element is transmitted in a beacon, and where the apparatus is an access point station of a wireless local area network.

17. (canceled)

18. A non-transitory computer-readable medium that contains software program instructions, where execution of the software program instructions by at least one data processor results in performance of operations that comprise execution of the method of claim 8.

19. An apparatus, comprising:
at least one data processor; and
at least one memory including computer program code, where the at least one memory and computer program code are configured, with the at least one data processor, to cause the apparatus at least to receive a signaling element comprising an indication whether there are buffered individually addressed frames for at least one device within a group of devices; to determine whether the apparatus belongs to a group for which there are no buffered individually addressed frames, based on the indication; and if it is determined that the apparatus belongs to a group for which there are no buffered individually addressed frames, to enter a lower power state without waiting to receive a next signaling element.

20. (canceled)

21. (canceled)

22. The apparatus as in claim 19, where the indication is included in a traffic indication bitmap information element received in a beacon, where the apparatus is comprised of a non-access point station of a wireless local area network, where there are N groups of devices, and where the indication comprises a bit in a group of N bits.

23. (canceled)

24. An apparatus, comprising:
at least one data processor; and
at least one memory including computer program code, where the at least one memory and computer program code are configured, with the at least one data processor, to cause the apparatus at least to assign individual ones of devices to one of a plurality of groups of devices and to transmit a signaling element to the devices, where the signaling element is comprised of a first plurality of i bits individual ones of which indicate for a plurality of i devices whether an associated one of the i devices has buffered data at the apparatus, the signaling element further comprising a second plurality of j bits individual ones of which indicate for an individual one of j groups of devices whether any device within the group has buffered data at the apparatus.

25. (canceled)

26. The apparatus as in claim 24, further comprising for at least one particular selected group of devices setting an associated one of the j bits to indicate that no device within the particular selected group has buffered data at the apparatus when there actually is buffered data at the apparatus for at least one of the devices within the particular selected group, and rotating over time the at least one particular selected group among the j groups of devices.

27. The apparatus as in claim 26, where a decision is made to set the associated one of the j bits, to indicate that no device within the particular selected group has buffered data at the apparatus, in order to at least reduce energy consumption by the devices within the particular selected group.

28. The apparatus as in claim 27, where the decision is made based at least in part on at least one of a quality of service criterion, an amount of buffered downlink data for the devices within the particular selected group, and application specific information related to the devices within the particular selected group of devices.

29. (canceled)

30. (canceled)

31. (canceled)

32. The apparatus as in claim 24, where the signaling element is transmitted in a beacon, and where the apparatus is an access point station of a wireless local area network.

33.-36. (canceled)
